(19) United States
(12) Patent Application Publication
(10) Pub. No.: US 2018/0004715 A1
(43) Pub. Date: Jan. 4, 2018

(54) OPTIMIZING VIEW HIERARCHY BY AUTOMATICALLY REMOVING LAYOUT-ONLY VIEWS

(71) Applicant: Facebook, Inc., Menlo Park, CA (US)

(72) Inventors: Andrew Lankes Street, Midlothian, VA (US); Spencer Ahrens, Redwood City, CA (US); Adam John Ernst, New York, NY (US)

(21) Appl. No.: 15/200,445

(22) Filed: Jul. 1, 2016

(51) Int. Cl. G06F 17/22; G06F 17/21

(52) U.S. Cl. CPC G06F 17/2241; G06F 17/212; G06F 17/2247

(57) ABSTRACT

Disclosed are ways to transform an unoptimized hierarchy of views into an optimized display view hierarchy that achieves the same user interface specified by the unoptimized hierarchy but with fewer views. Various embodiments of the present disclosure render pages more quickly and with less overhead by automatically removing “layout-only” views that may affect the positioning of other views but are not drawn themselves. Reducing the number of views created and the depth of the display view hierarchy decreases memory usage and improves computing device display system performance and reliability.

### BACKGROUND

Computing devices display information via user interfaces. It is common for user interface systems to render “views” on a screen or page that are generally composed of rectangles or boxes that each contain or arrange content, such as pictures or text. Such views or elements may be organized in a hierarchical structure, such as a tree. For example, web pages are conventionally represented using a Document Object Model (“DOM”) to organize and represent objects in HTML, XHTML, and XML documents. Web browsers and scripting languages such as JavaScript® use a DOM or a similar internal logical model of a page as nodes in a tree or similar data structure to parse, display, address, and manipulate elements on the page. Native display systems, such as iOS® and Android™, can use similar hierarchical models to represent views for display on various computing device user interfaces. Rendering user interface elements generally requires computation that can slow down an application or cause the application to appear to be sluggish.

### BRIEF DESCRIPTION OF THE DRAWINGS

FIG. 1 is a block diagram showing some of the components typically incorporated in computer systems and other devices on which a system that provides layout-only view removal can be implemented.

FIG. 2 is a system diagram illustrating an example of a computing environment 200 in which a layout-only view removal system can be utilized.

FIG. 3 is a data flow diagram illustrating logical relationships among view hierarchy optimization components in accordance with an embodiment.

FIGS. 4A and 4B are display diagrams illustrating removal of layout-only views in accordance with an embodiment.

FIGS. 5A and 5B are tree diagrams illustrating removal of layout-only views in accordance with an embodiment.

FIG. 6 is a flow diagram illustrating a process for a computer system to optimize out layout-only views in accordance with an embodiment.

FIG. 7 is a flow diagram illustrating a process for a view hierarchy optimization system to determine whether to render a view in accordance with an embodiment.

FIG. 8 is a flow diagram illustrating a process for a view hierarchy management system to render a formerly layout-only view in accordance with an embodiment.

### DETAILED DESCRIPTION

### Overview

Some views in a hierarchy of views do not themselves require anything to be drawn to the screen. For example, it is common for user interface programmers to use containers to affect layout (e.g., using cascading style sheets (“CSS”) flexible box or “flexbox” containers, or various other user interface properties regarding spacing, padding, positioning, etc.) and/or to wrap one or more objects in a page with a surrounding container (e.g., for programming convenience). Such views may be termed “layout-only” views because they have no substantive content or effects drawn to the screen other than possibly affecting the layout of other views. The inventors of the present disclosure have determined that layout-only views that are only used to control the layout of other views (e.g., child nodes that are below the view in a hierarchical data structure) or otherwise do not draw anything may be automatically removed from the hierarchy as an optimization. This works because any effects of the layout-only views on the layout of other views can be calculated before rendering, and once those other views are positioned, the layout-only views can safely be removed.

The present disclosure describes view hierarchy optimization by layout-only view removal including systems and methods for rendering pages more quickly and with less overhead by automatically removing “layout-only” views that may affect the positioning of other views but are not drawn themselves. In some implementations, a system maintains both an unoptimized original hierarchy (e.g., a “shadow” hierarchy) and an optimized hierarchy (e.g., a “native” hierarchy of native elements for rendering by a computing device's user interface display system). By transforming view tree operations (e.g., to create, add, or remove nodes in the tree), such a system can receive changes to the original hierarchy and accurately render them in the optimized hierarchy so that the transformation is invisible to users. For example, an embodiment of such a system can translate between the unoptimized original view hierarchy and an optimized native view hierarchy. This translation enables optimization transforms on the native hierarchy, such as identifying a node that will not be rendered and maintaining its effects on the positioning of other nodes while omitting the identified node from the native hierarchy. Once a view has been optimized out of the hierarchy, an operation that would affect that view (e.g., to add or remove a child view, or change the properties of the view) can be transformed to be performed on other nodes that are actually rendered. If the operation would cause the omitted view to draw something to the screen, the view can be added to the optimized hierarchy.

Some embodiments can include a system for maintaining both an unoptimized original hierarchy of views and an optimized hierarchy of views. For example, the applicant of the present disclosure has developed a “React” JavaScript® library for building user interfaces. The React system enables a user to compose reusable user interface components and subcomponents to render views. When a page or a part of a page needs to be rendered (e.g., when it is initially displayed or updated), React returns a tree of components that will eventually be rendered (for example, to HTML elements like <div> or <span>, or to native display elements like text or image elements, such as MKMapView in iOS® or ImageView in Android™). React creates a data structure mirroring the original hierarchy of views, computes any differences resulting from a change to the displayed views, and then updates the displayed hierarchy efficiently. This allows a programmer to write code as if the entire page is rendered on each change while the React libraries only render subcomponents that actually change. React computes the minimal set of changes necessary to keep the displayed hierarchy of views up-to-date. Although many embodiments are described herein in the context of React, embodiments are not limited to React or to rendering only updated views as determined by React libraries.

Various embodiments enable optimization of views rendered for display in various environments. For example, rendering a complex view hierarchy in an Android™ device can pose challenges because of limited stack depth; rendering a dozens-deep tree of views, each causing several method calls, can put enough calls on the stack to cause a stack overflow. Because each view costs memory and time to construct and configure, rendering a large hierarchy of views can also require a large amount of memory to be allocated for the rendered views, potentially running up against memory limits for an Android™ application, as well as taking up CPU time. Embodiments operating in some or all of the ways described above can reduce the number of views created and reduce the depth of the displayed view hierarchy, resulting in faster display rendering, lower memory usage, improved memory management (e.g., reduced garbage collection times), and fewer stack overflow exceptions.

### DESCRIPTION OF FIGURES

The following description provides certain specific details of the illustrated examples. One skilled in the relevant art will understand, however, that embodiments can be practiced without many of these details. Likewise, one skilled in the relevant art will also understand that the present disclosure can include many other obvious features not described in detail herein. Additionally, some well-known structures or functions may not be shown or described in detail below, to avoid unnecessarily obscuring the relevant descriptions of the various examples.

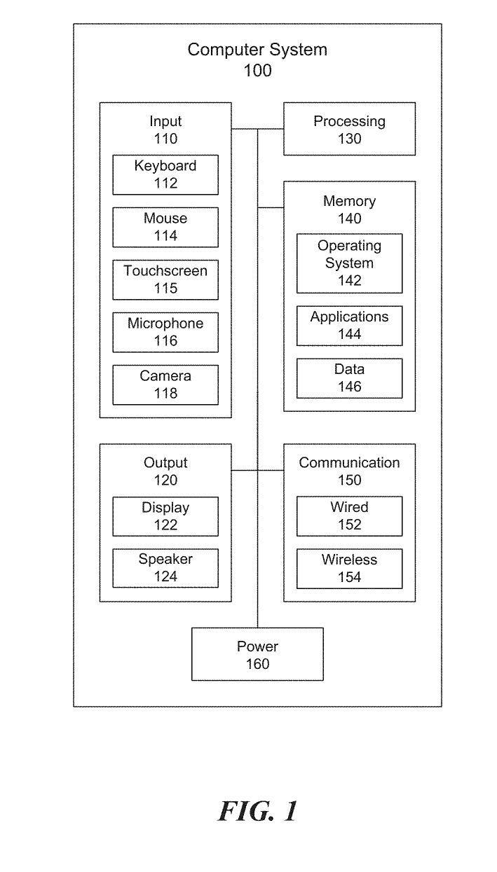

FIG. 1 is a block diagram showing some of the components typically incorporated in computing systems and other devices on which a system that provides layout-only view removal can be implemented. In the illustrated embodiment, the computer system 100 includes a processing component 130 that controls operation of the computer system 100 in accordance with computer-readable instructions stored in memory 140. The processing component 130 may be any logic processing unit, such as one or more central processing units (CPUs), graphics processing units (GPUs), digital signal processors (DSPs), field-programmable gate arrays (FPGAs), application-specific integrated circuits (ASICs), etc. The processing component 130 may be a single processing unit or multiple processing units in an electronic device or distributed across multiple devices. Aspects of the system can be embodied in a special purpose computing device or data processor that is specifically programmed, configured, or constructed to perform one or more of the computer-executable instructions explained in detail herein. Aspects can also be practiced in distributed computing environments in which functions are performed by local and/or remote processing devices that are linked through a communications network, such as a local area network (LAN), wide area network (WAN), or the Internet.

The processing component 130 is connected to memory 140, which can include a combination of temporary and/or permanent storage, and both read-only memory (ROM) and writable memory (e.g., random access memory or RAM, CPU registers, and on-chip cache memories), writable non-volatile memory such as flash memory or other solid-state memory, hard drives, removable media, magnetically or optically readable discs and/or tapes, nanotechnology memory, synthetic biological memory, and so forth. A memory is not a propagating signal divorced from underlying hardware; thus, a memory and a computer-readable storage medium do not refer to a transitory propagating signal per se. The memory 140 includes data storage that contains programs, software, and information, such as an operating system 142, application programs 144, and data 146. Computer system 100 operating systems 142 can include, for example, Windows®, Linux®, Android™, iOS®, and/or an embedded real-time operating system. The application programs 144 and data 146 can include software and databases—including data structures, database records, other data tables, etc.—configured to control computer system 100 components, process information (to, e.g., optimize view hierarchy data), communicate and exchange data and information with remote computers and other devices, etc. In a distributed computing environment, program modules and data can be located in both local and remote memory storage devices.

In some embodiments, the memory 140 includes program memory that contains programs and software, and data memory that includes configuration data, settings, preferences, files, documents, etc. that may be accessed by instructions from the program memory or by a component of the computing system 100. Program memory can include modules of the operating system 142 and application programs 144, such as a view hierarchy management system and view rendering software for displaying views according to the present disclosure, and communication software for transmitting and receiving data by various channels and protocols via the communication components 150.

The computer system 100 can include input components 110 that receive input from user interactions and provide input to the processor 130, typically mediated by a hardware controller that interprets the raw signals received from the input device and communicates the information to the processor 130 using a known communication protocol. Examples of an input component 110 include a keyboard 112 (with physical or virtual keys), a pointing device (such as a mouse 114, joystick, dial, or eye tracking device), a touchscreen 115 that detects contact events (e.g., when it is touched by a user), a microphone 116 that receives audio input (e.g., for systems implementing speech recognition as a method of input by the user), and a camera 118 for photograph and/or video capture. The computer system 100 can also include various other input components 110 such as GPS or other location determination sensors, motion sensors, wearable input devices with accelerometers (e.g. wearable glove-type or head-mounted input devices), biometric sensors (e.g., a fingerprint sensor), light sensors (e.g., an infrared sensor), card readers (e.g., a magnetic stripe reader or a memory card reader), and so on.

The processor 130 can also be connected to one or more various output components 120, e.g., directly or via a hardware controller. The output devices can include a display 122 on which text and graphics are displayed. The display 122 can be, for example, an LCD, LED, or OLED display screen (such as a desktop computer screen, handheld device screen, or television screen), an e-ink display, a projected display (such as a heads-up display device), and/or a display integrated with a touchscreen 115 that serves as an input device as well as an output device that provides graphical and textual visual feedback to the user. The output devices can also include a speaker 124 for playing audio signals, haptic feedback devices for tactile output such as vibration, etc. In some implementations, the speaker 124 and the microphone 116 are implemented by a combined audio input-output device.

In the illustrated embodiment, the computer system 100 further includes one or more communication components 150. The communication components can include, for example, a wired network connection 152 (e.g., one or more of an Ethernet port, cable modem, FireWire cable, Lightning connector, universal serial bus (USB) port, etc.) and/or a wireless transceiver 154 (e.g., one or more of a Wi-Fi transceiver; Bluetooth transceiver; near-field communication (NFC) device; wireless modem or cellular radio utilizing GSM, CDMA, 3G and/or 4G technologies; etc.). The communication components 150 are suitable for communication between the computer system 100 and other local and/or remote computing devices, directly via a wired or wireless peer-to-peer connection and/or indirectly via a communication link and networking hardware, such as switches, routers, repeaters, electrical cables and optical fibers, light emitters and receivers, radio transmitters and receivers, and the like (which can include the Internet, a public or private intranet, a local or extended Wi-Fi network, cell towers, the plain old telephone system (POTS), etc.). The computer system 100 further includes power 260, which can include battery power and/or facility power for operation of the various electrical components associated with the computer system 100.

FIG. 1 and the discussion herein provide a brief, general description of a suitable computing environment in which a system providing layout-only view removal can be implemented. Although not required, aspects of the system are described in the general context of computer-executable instructions, such as routines executed by a general-purpose computer, e.g., a mobile device, a server computer, or a personal computer. Those skilled in the relevant art will appreciate that the system can be practiced using other communications, data processing, or computer system configurations, e.g., hand-held devices (including tablet computers, personal digital assistants (PDAs), and mobile phones), laptop computers, wearable computers, vehicle-based computers, multi-processor systems, microprocessor-based consumer electronics, set-top boxes, network appliances, mini-computers, mainframe computers, virtual computing platforms, distributed computing environments that include any of the above systems or devices, etc. The terms “computer,” “computing device,” and “electronic device” are generally used interchangeably herein, and refer to any such data processing devices and systems. While computer systems configured as described above are typically used to support the operation of a system implementing layout-only view removal, one of ordinary skill in the art will appreciate that embodiments may be implemented using devices of various types and configurations, and having various components.

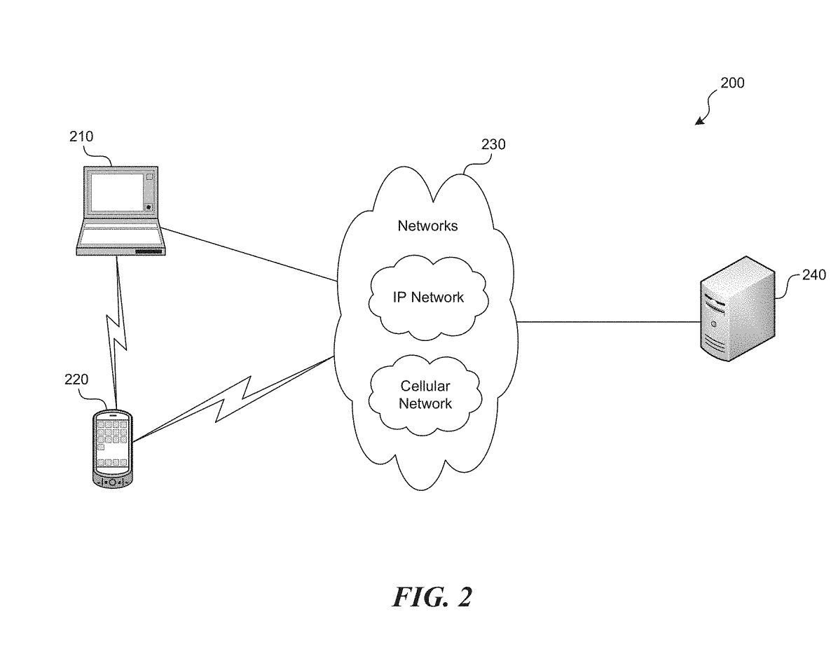

FIG. 2 is a system diagram illustrating an example of a computing environment 200 in which a layout-only view removal system can be utilized. As illustrated in FIG. 2, a layout-only view removal system can operate on various computing devices, such as a computer 210, mobile device 220 (e.g., a mobile phone, tablet computer, mobile media device, mobile gaming device, wearable computer, etc.), and other devices capable of receiving user inputs (e.g., such as a set-top box or vehicle-based computer). Each of these devices can include various input mechanisms (e.g., microphones, keypads, cameras, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 that, e.g., coordinates view hierarchy data structure information across user devices and/or performs computations regarding views or a view hierarchy. System 240 can be maintained in a cloud-based environment or other distributed server-client system. As described herein, user input (e.g., trace input via a virtual keyboard) can be communicated between devices 210 and 220 and/or to the system 240. In addition, information about the user or the user's device(s) 210 and 220 (e.g., the current and/or past location of the device(s), views displayed on each device, device characteristics, and user preferences and interests) can be communicated to the system 240. In some implementations, some or all of the system 240 is implemented in user computing devices such as devices 210 and 220.

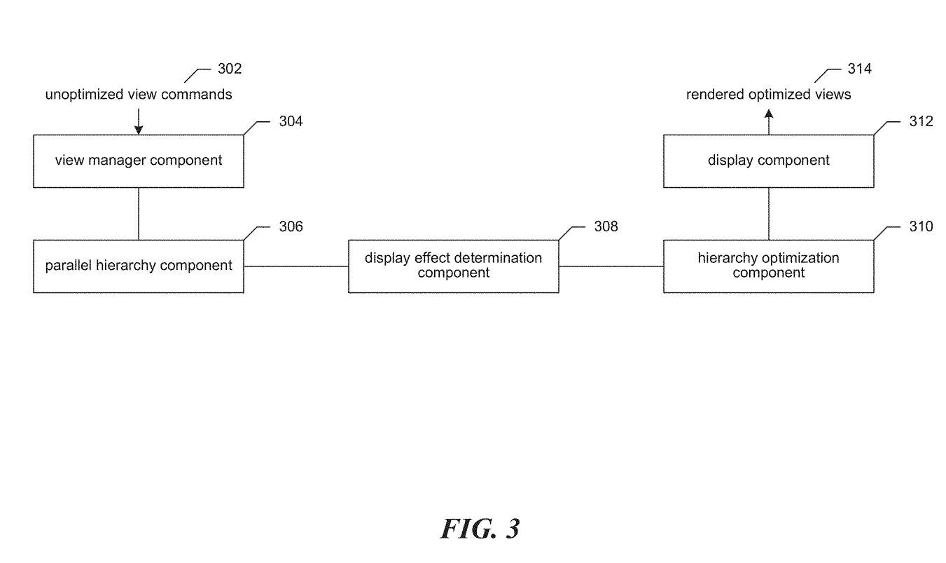

FIG. 3 is a data flow diagram illustrating logical relationships among view hierarchy optimization components in accordance with an embodiment. In various embodiments, a computing system such as the computer system 100 of FIG. 1 and/or one or more other processing devices operably connectable to the computer system, such as a remote computing server, can implement the view hierarchy optimization components and the data flows depicted in FIG. 3. In the illustrated embodiment, unoptimized view commands 302 are provided to a view manager component 304. In various embodiments, the unoptimized view commands 302 can include directives to render a page of views, add a node to a tree of views, modify the properties of a view, etc. For example, the command may add or remove child nodes of the view, or modify child nodes of the view. The view manager component 304 can receive views, or a hierarchy of views, or commands regarding how to render or modify views, from a native application, an operating system user interface framework, a web browser, etc. In some embodiments, the view manager component 304 is a software component in a computing system display library or framework, e.g., a React system UIManagerModule class.

In the illustrated embodiment, the view manager component 304 is connected to a parallel hierarchy component 306. The parallel hierarchy component 306 can maintain multiple versions of the hierarchy specified by the unoptimized view commands 302. For example, the parallel hierarchy component 306 can maintain a lightweight virtual “shadow” hierarchy paralleling the unoptimized original hierarchy. The parallel hierarchy component 306 can also generate a display hierarchy for optimization before rendering. The display effect determination component 308 is configured to identify whether, for a given view, the received view commands have any substantive effects that would cause anything to be displayed on the screen, other than possibly affecting the layout of other views. In some embodiments, the display effect determination component sets a flag designating a view having no substantive display effects as layout-only. In some embodiments, the display effect determination component 308 is also configured to identify whether the view is designated as collapsible, enabling a programmer to explicitly indicate that the view should not be optimized away even if it is a layout-only view. In some embodiments, the display effect determination component is configured to determine whether the view has been rendered or designated for rendering, so that if it is, the view will not be omitted from the hierarchy of views even if or in the event that the command does not have any effect on the view other than layout. For example, this can prevent an element from being repeatedly added and removed from a hierarchy (e.g., in the case of an animation) where that would be inefficient.

Using the view information from the display effect determination component 308, a hierarchy optimization component 310 modifies the hierarchy of views by omitting layout-only views from the hierarchy. For example, if or in the event that a received command to generate a view has no effect other than adjusting the layout of other views, the hierarchy optimization component 310 can omit the view from the display hierarchy before the rendering process. By omitting the view, memory resources that would be allocated to the view are saved, and the depth of the display hierarchy is reduced in comparison to the unoptimized original hierarchy. A display component 312 renders the display hierarchy (e.g., via a native application programming interface (API) for rendering views, or a web browser XML DOM rendering engine) and displays the rendered optimized views 314 after the omitting of views by the hierarchy optimization component 310.

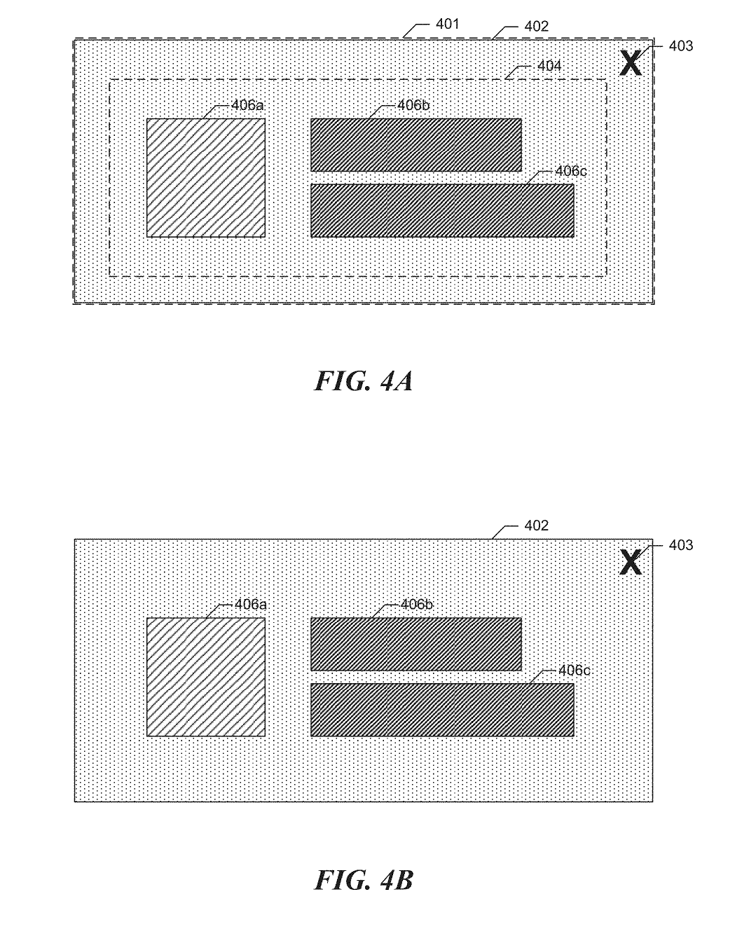

FIGS. 4A and 4B are display diagrams illustrating removal of layout-only views in accordance with an embodiment. It is common to express view layout in relative terms, for example, to have two rectangles share screen width and be spaced a certain distance or centered within their parent. Accordingly, programmers use views to move around “children” of the views (e.g., elements or properties the views contain), such as padding, spacing, and/or positioning elements on a page. Once a parent view has been used to compute layout values to position those elements, if the parent view is not actually rendering anything, it is no longer needed for rendering purposes. The addressability of the parent view is convenient for the original author, but not needed for the renderer and irrelevant to the ultimate viewer. To avoid rendering many views that are not necessary, layout-only views can be omitted from the view hierarchy before the hierarchy is rendered.

In the example illustrated in FIGS. 4A and 4B, view hierarchy commands specify a series of rectangles to be rendered. FIG. 4A illustrates the unoptimized hierarchy, e.g., the full hierarchy specified by a programmer. A container view 401 provides a single element that wraps all of the views within it. A large rectangle view 402 draws a background color and a border box. A text element 403 displays an “X” in the upper right corner. A positioning view 404 ensures that element views 406 are properly spaced within the large rectangle view 402. Individual element views 406a, 406b, and 406c are displayed within the positioning view 404.

FIG. 4B illustrates an optimized hierarchy after the removal of layout-only views from the hierarchy illustrated in FIG. 4A. In particular, the container view 401 and the positioning view 404 of FIG. 4A are omitted from the optimized hierarchy of FIG. 4B. The container view 401 of FIG. 4A has no display or layout effects. The positioning view 404 of FIG. 4A has layout effects on the individual element views 406, but no display effects itself. Thus, the omission of those views from the optimized display hierarchy has no perceptible visual effect from a viewer's perspective, while the maximum depth of the nested views is reduced from four (401-402-404-406) to two (402-406). The individual elements 406a, 406b, and 406c are displayed directly within the large rectangle view 402, with the spacing effects from the positioning view 404 applied directly to the individual elements 406a, 406b, and 406c.

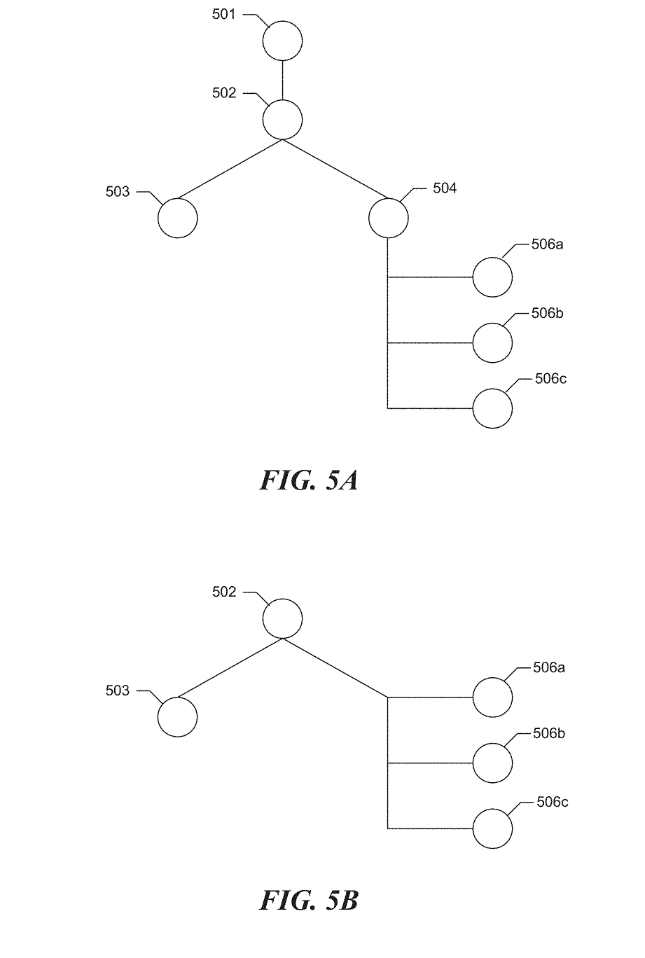

FIGS. 5A and 5B are tree diagrams illustrating removal of layout-only views in accordance with an embodiment. The tree diagram illustrated in FIG. 5A represents an unoptimized hierarchy of views corresponding to the unoptimized views illustrated in FIG. 4A. Root node 501, for example, corresponds to the container view 401 of FIG. 4A. Similarly, node 502 corresponds to the large rectangle view 402; node 503 corresponds to the text element 403; node 504 corresponds to the positioning view 404; and nodes 506a-c correspond to the individual element views 406a-c.

The tree diagram illustrated in FIG. 5B represents an optimized hierarchy of views corresponding to the optimized views illustrated in FIG. 4B. For example, because the container view 401 of FIG. 4A has no display or layout effects, the root node 501 is omitted from FIG. 5B, and node 502 is the new root node. In addition, because the positioning view 404 of FIG. 4A is omitted from the optimized hierarchy of views, node 504 has also been removed from the tree. The children of former node 504, nodes 506a-c, are now direct children of node 502. Accordingly, while the depth of the tree illustrated in FIG. 5A is four and it contains a total of seven nodes, the depth of the tree illustrated in FIG. 5B is only two, and it contains a total of just five nodes.

Although the contents and organization of the tree diagrams of FIGS. 5A and 5B are designed to make them more comprehensible by a human reader, those skilled in the art will appreciate that actual data structures used to store this information can differ from the trees shown. For example, they can be organized in a different manner (e.g., in multiple different data structures, of various types (e.g., linked lists, arrays, queues, heaps, hash tables, and so on)); can contain more or less information than shown; can be compressed and/or encrypted; etc.

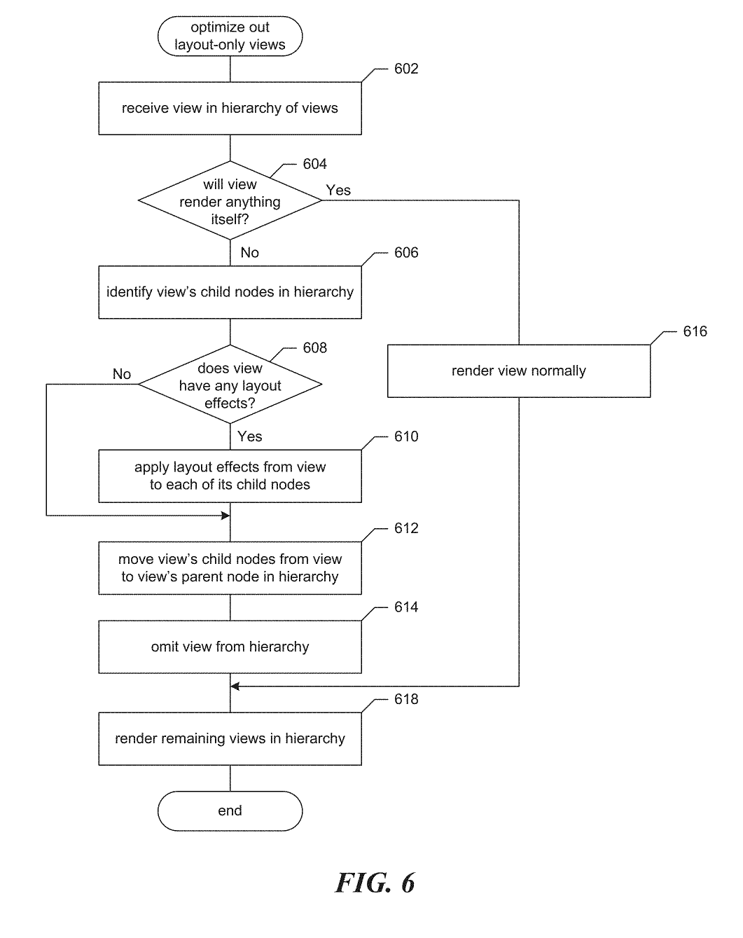

FIG. 6 is a flow diagram illustrating a process for a computer system (e.g., the computing system 100 of FIG. 1) to optimize out layout-only views in accordance with an embodiment. In block 602, the computer system (e.g., the view manager component 304 of FIG. 3) and receives a view in a hierarchy of views. In various embodiments, the computer system receives a command to render a hierarchy of nodes, such as the tree diagram illustrated in FIG. 5A, in which each node represents a view for potential rendering for display. Such a complete hierarchy of nodes, while easy for a programmer to reason about, can be inefficient to translate directly to display views for rendering. Accordingly, the process illustrated in FIG. 6 is responsible for optimizing the display view hierarchy while respecting the final user interface specified by the unoptimized hierarchy of views.

In decision block 604, the computer system determines whether the view received in block 602 will render anything itself. For example, the computer system can analyze whether the view only affects the position of elements on a display screen, as opposed to drawing an image, background color, text, etc. If the computer system detects that the view would actually render anything, then in block 616, it renders the view normally as a necessary part of the view hierarchy.

Otherwise, the computer system will not render the view, but instead will mark the node as layout-only and proceed to blocks 606-614 to omit the node from being created in the display hierarchy. To omit a layout-only node, the computer system identifies any differences in layout that the view would cause to any child views, and applies those differences to its children directly. Thus, in block 606, the system identifies the view's child nodes in the hierarchy, if any. In decision block 608, the computer system determines whether the view has any layout effects. If not (e.g., for a wrapper container with no positioning impact, such as the container view 401 of FIG. 4A), the process continues in block 612. Otherwise, the process continues in block 610.

In block 610, the computer system applies the layout effects from the view to each of its child nodes. In some embodiments, nodes for some or all views in the display hierarchy include data fields to store absolute coordinates (e.g., left, top, right, and bottom positions) for rendering the views on a display screen or window. The computer system can calculate the layout effects of the layout-only view, and record the resulting coordinates of its child views in those child views' data fields. Once the positioning data is recorded in the child nodes, the layout-only view is no longer needed. To remove it from the hierarchy, however, its child nodes must be saved. In block 612, the computer system moves the view's child nodes from the view to the view's parent node in the hierarchy (e.g., making the child nodes siblings of the view). In block 614, with the child nodes removed from the view, the computer system omits the view from the hierarchy of views for display. As a result, the display view hierarchy sent to the rendering system (e.g., the display component 312 of FIG. 3) is not an exact copy of the originally received hierarchy of views, even though the same visual information is displayed. In block 618, the computer system renders the remaining views in the hierarchy. Because the view was omitted from the hierarchy in block 614, however, the rendering system does not create the view, reducing the computing system's rendering load.

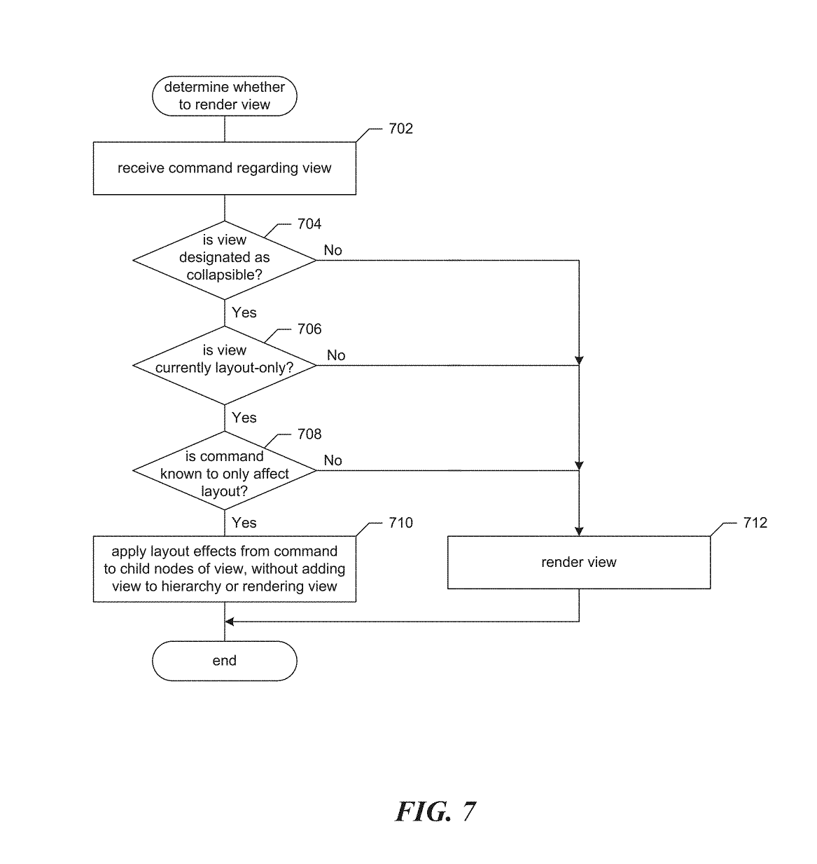

FIG. 7 is a flow diagram illustrating a process for a view hierarchy optimization system to determine whether to render a view in accordance with an embodiment. In block 702, the system receives a command regarding a view. For example, the system may receive a command to render the view (e.g., a rectangle), change a background color, add or modify a child view, revise a spacing property, etc. The command may be associated with initial rendering of the view, or a change to the view on an already-displayed page.

In decision block 704, the system determines whether the view is designated as collapsible. In some embodiments, a Boolean “collapsible” property, if set to “false,” enables a programmer or page author to disable layout-only view optimization for individual views to ensure that the view exists in the native view hierarchy. If the view is designated as not collapsible, then in block 712 the system proceeds to render the view. Otherwise, the process continues in block 706.

In decision block 706, the system determines whether the view, if previously analyzed by the view hierarchy optimization system, is marked as layout-only. In some embodiments, if the view is marked as not layout-only, then it will not be demoted, even if the command would make the node layout-only. In such embodiments, once a view is created in the display hierarchy, it stays created. For example, in an animation, a node might go from layout-only to non-layout-only and back again; however, to avoid churn, a node that has been created can be left in the hierarchy. In some embodiments, the system assumes that a node is layout-only unless marked otherwise. If the view is marked as not layout-only, then in block 712 the system proceeds to render the view. Otherwise, the process continues in block 708.

In decision block 708, the system determines whether the command is known to only affect layout. In some embodiments, the system defaults to an assumption that all properties changed other than specific layout-only properties will cause rendering. For example, the system can compare the command to a whitelist of commands that do not cause a layout-only view to draw anything that would be rendered. If the command is not known to only affect layout, then in block 712 the system proceeds to render the view. Otherwise, the process continues in block 710. In block 710, the command has been determined not to cause the view to be rendered. Accordingly, the system applies the layout effects from the command to the child nodes of the view (if any), without adding the view to the display hierarchy of views and thus without rendering the view.

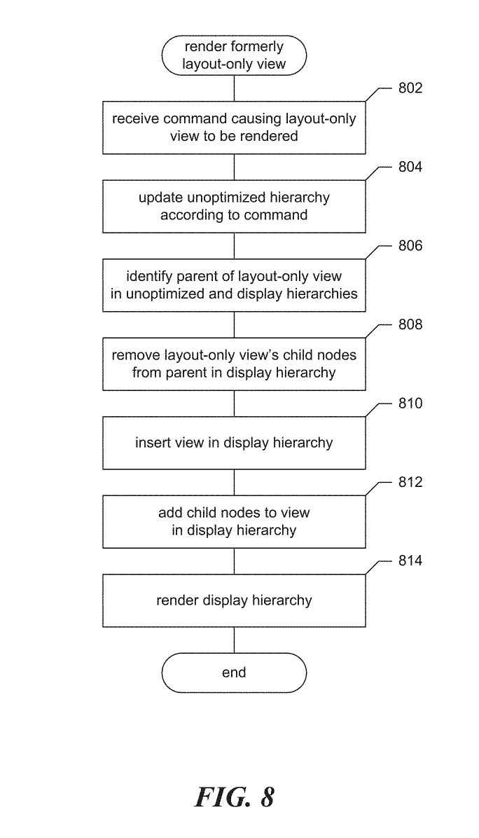

FIG. 8 is a flow diagram illustrating a process for a view hierarchy management system to render a formerly layout-only view in accordance with an embodiment. In some situations, such a view management system may need to update a layout-only view to have properties that cause it to render and no longer be layout-only. For example, a view such as the positioning view 404 of FIG. 4A could be updated with a background color or an accessibility tag, requiring it to be created, added to the display view hierarchy, and rendered as part of the display view hierarchy.

In block 802, the system receives a command causing a layout-only view to be rendered, so that the view is no longer layout-only. In block 804, the system updates the unoptimized hierarchy according to the effects of the command. The view is present in the unoptimized hierarchy; however, as a layout-only view, it has been omitted from the display hierarchy. In block 806, the system identifies the parent of the layout only view in the unoptimized and display hierarchies. Because the view does not exist in the display hierarchy, its children in the unoptimized hierarchy are children of the parent node in the display hierarchy. In block 808, the system removes the view's child nodes from the parent in the display hierarchy and puts them aside. In block 810, the system creates the previously omitted view and inserts it in the display hierarchy under its parent view. In block 812, the system takes the put-aside child nodes and adds them back as children of the view in the display hierarchy. In some embodiments, layout effects of the view are recalculated when the view is inserted into the display hierarchy. In some embodiments, only layout effects affected by the command are updated. In block 814, the system renders the revised display hierarchy including the view.

Embodiments operating in some or all of the ways described above provide a page rendering infrastructure that reduces memory footprint and processor utilization, improves reliability, and improves page display speed.

### CONCLUSION

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited except as by the appended claims.

We claim:

1. A method performed by a computing system having memory and a processor for optimizing a hierarchy of views before rendering the optimized hierarchy of views for display, comprising:
receiving a view in the hierarchy of views;
determining that the view does not require any substantive rendering;
identifying any child node views in the hierarchy of views that are child nodes of the view;
applying layout effects of the view to the child node views;
identifying a view in the hierarchy of views that is a parent node of the view;
moving the child node views in the hierarchy from being child nodes of the view to being child nodes of the parent node of the view; and
omitting the view from the hierarchy of views.

2. The method of claim 1 wherein the hierarchy of views comprises information about elements in an HTML or XML document object model.

3. The method of claim 1 wherein the hierarchy of views comprises information about native elements in a mobile device display environment.

4. The method of claim 1, further comprising maintaining an unoptimized hierarchy of views in parallel with the optimized hierarchy, wherein the unoptimized hierarchy of views is not rendered for display.

5. The method of claim 1 wherein determining whether the view requires any substantive rendering comprises comparing any properties or changes to properties of the view to a whitelist of properties known not to cause substantive rendering.

6. The method of claim 1 wherein determining whether the view requires any substantive rendering comprises determining whether the view has been rendered or designated for rendering,
wherein a view that has been rendered or designated for rendering is not omitted from the hierarchy of views even in the event that the view does not require any substantive rendering.

7. The method of claim 1, further comprising:
receiving a command regarding a view omitted from the hierarchy of views that causes the view to require substantive rendering;
removing the child node views in the hierarchy from the parent node of the view;
inserting the view into the hierarchy of views; and
adding the child node views in the hierarchy as child nodes of the view.

8. A computer-readable storage medium storing computer-executable instructions for causing a computing system having a processor to optimize a hierarchy of views before rendering the hierarchy of views for display, the instructions comprising:
instructions for receiving a view in the hierarchy of views;
instructions for determining, by the processor, that the view does not require any substantive rendering;
instructions for identifying any views in the hierarchy of views that are child nodes of the view;
instructions for applying layout effects of the view to the child node views;
instructions for identifying a view in the hierarchy of views that is the parent node of the view;
instructions for moving the child node views in the hierarchy from being child nodes of the view to being child nodes of the parent node of the view; and
instructions for omitting the view from the hierarchy of views.

9. The computer-readable storage medium of claim 8 wherein the hierarchy of views comprises information about elements in an HTML or XML document object model.

10. The computer-readable storage medium of claim 8 wherein the hierarchy of views comprises information about native elements in a mobile device display environment.

11. The computer-readable storage medium of claim 8, further comprising instructions for maintaining an unoptimized hierarchy of views in parallel with the optimized hierarchy, wherein the unoptimized hierarchy of views is not rendered for display.

12. The computer-readable storage medium of claim 8 wherein the instructions for determining whether the view requires any substantive rendering comprise instructions for comparing any properties or changes to properties of the view to a whitelist of properties known not to cause substantive rendering.

13. The computer-readable storage medium of claim 8 wherein the instructions for determining whether the view requires any substantive rendering comprise instructions for determining whether the view has been rendered or designated for rendering,
wherein a view that has been rendered or designated for rendering is not omitted from the hierarchy of views even in the event that the view does not require any substantive rendering.

14. The computer-readable storage medium of claim 8, further comprising:
instructions for receiving a command regarding a view omitted from the hierarchy of views that causes the view to require substantive rendering;
instructions for removing the child node views in the hierarchy from the parent node of the view;
instructions for inserting the view into the hierarchy of views; and
instructions for adding the child node views in the hierarchy as child nodes of the view.

15. A system in a computing device for optimizing a hierarchy of views for display on a screen of the computing device, comprising:
a view manager component configured to receive a command regarding a view in the hierarchy of views;
a display effect determination component configured to identify whether the received command has any effect on the view other than layout;
a hierarchy optimization component configured to, in the event that the received command has no effect on the view other than layout, omit the view from the hierarchy; and
a display component configured to display the hierarchy after the omitting of views by the hierarchy optimization component.

16. The system of claim 15 wherein the display effect determination component is configured to identify whether the view is designated as collapsible.

17. The system of claim 15, further comprising a parallel hierarchy component configured to maintain an unoptimized hierarchy of views in parallel with the optimized hierarchy, wherein the unoptimized hierarchy of views is not rendered for display.

18. The system of claim 17 wherein the display effect determination component is further configured to set a flag designating the view in the unoptimized hierarchy as layout-only.

19. The system of claim 15 wherein the command comprises a directive to change properties of the view, add or remove child nodes of the view, or modify child nodes of the view.

20. The system of claim 15 wherein the display effect determination component is configured to determine whether the view has been rendered or designated for rendering,
wherein the hierarchy optimization component is configured not to omit a view that has been rendered or designated for rendering from the hierarchy of views even in the event that the command does not have any effect on the view other than layout.
